(19) United States
(12) Patent Application Publication
(10) Pub. No.: US 2015/0187306 A1
(43) Pub. Date: Jul. 2, 2015

(54) SYSTEM AND METHOD FOR POOR DISPLAY REPAIR FOR LIQUID CRYSTAL DISPLAY PANEL

(71) Applicants: Shen-Sian Syu, Shenzhen (CN); Chun-Huai Li, Shenzhen (CN)

(72) Inventors: Shen-Sian Syu, Shenzhen (CN); Chun-Huai Li, Shenzhen (CN)

(73) Assignee: SHENZHEN CHINA STAR OPTOELECTRONICS TECHNOLOGY CO., LTD., Shenzhen, Guangdong (CN)

(21) Appl. No.: 14/241,798

(22) PCT Filed: Jan. 21, 2014
(86) PCT No.: PCT/CN2014/071022

§ 371 Date: Feb. 27, 2014

(30) Foreign Application Priority Data
Dec. 30, 2013 (CN) 201310746103.8

(51) Int. Cl. G09G 3/36

(52) U.S. Cl. CPC G09G 3/3655; G09G 3/3677; G09G 2300/0426; G09G 2310/067; G09G 2310/08; G09G 2320/0209; G09G 2320/0219; G09G 2320/0223; G09G 2320/0233; G09G 2320/0247; G09G 2320/029; G09G 2320/046; G09G 2320/0693; G09G 2320/08; G09G 2360/147; G09G 2360/16

(57) ABSTRACT

The present disclosure provides a system and method for repairing poor display in a liquid crystal display panel. The system comprises: an image acquisition device for acquiring image data of the liquid crystal display panel containing poor display areas; a lossless compression module for calculating difference values between the acquired image data to perform lossless compression; a storage for storing data after the lossless compression; and a Mura repair module for decompressing the data in the storage, and repairing Mura of the decompressed original image data to generate information feed to the liquid crystal display panel. In the present invention, the acquired image data are stored in the storage, after being subjected to the lossless compression/decompression, and goes through the Mura repair, and then is output to the panel, such that both the capacity of the storage and the cost can be reduced without degrading the effect of De-Mura processing.

### FIELD OF THE INVENTION

The present disclosure relates to a liquid crystal display, and particularly, to a system and method for repairing poor display in a liquid crystal display panel.

### BACKGROUND OF THE INVENTION

In recent years, with the display trend of thinness, liquid crystal display (LCD) has been widely used in various electronic products, such as mobile phones, notebook computers and color televisions and the like.

In preparation, display non-uniformity corresponding to pressure, scratch, deviation, vibration and pollution brought by equipments and tools, or to pixel characteristic variation caused by the environment temperature and drive conditions are possibly seen finally during display monitoring. Various traces due to brightness non-uniformity on a display screen are collectively known as Mura. There are three major expressions of Mura: (1) a few dark display portions may be seen in a bright screen; (2) a few bright display portions may be seen in a dark screen; (3) bright or dark display portions may be seen in intermediate gray-scale screens. Mura is a very common phenomenon degrading display quality, and the formation thereof is intricate.

As the requirements of users on the quality of a thin film transistor-liquid crystal display (TFT-LCD) being higher and higher, those skilled in TFT-LCD are looking for approaches to improve manufacturing procedures so as to reduce Mura. Among these, after a liquid crystal display panel is produced, configuration of a grayscale coefficient (Gama) of Mura areas may be adjusted to be in accordance with a grayscale coefficient of normal area during a later-period system adjustment, so that the uniformity of the panel can be improved and the probability of Mura to be observed can be decreased. A process of adjusting the brightness of the Mura areas is referred to as a De-Mura process by those skilled in the art.

Among these, one method is to reduce the influence of Mura by means of digital compensation. Firstly, a display screen containing the Mura areas is shot by a camera, then an initial Mura state is recorded in EEPROM of a control board, and then values in an original image and values pre-stored in the EEPROM are subjected to a De-Mura algorithm to reduce Mura defects. In the case, the EEPROM needs a large capacity to store the information of Mura. However, as degree of resolution for large size LCD is higher and higher, the capacity of the EEPROM is much larger, such that the cost and space for this are increased.

Therefore, one of projects dedicated in the domain is how to solve the above-mentioned problem, in order to effectively improve the display effect of the liquid crystal display panel and reduce Mura with no increase for the cost and storage space.

### SUMMARY OF THE INVENTION

One of the technical problems to be solved in the present disclosure is to provide a system for repairing poor display in a liquid crystal display panel without increasing the storage space and cost in a Mura repair process. In addition, a method for repairing poor display in the liquid crystal display panel is further provided.

In order to solve the above-mentioned technical problems, the present disclosure provides a system for repairing poor display in a liquid crystal display panel, comprising: an image acquisition means, for acquiring image data of the liquid crystal display panel containing poor display areas; and a control board, electrically connected with the liquid crystal display panel, which comprises: a lossless compression module, a storage and a Mura repair module, wherein the lossless compression module is used for calculating difference values between the acquired image data to perform lossless compression; the storage is used for storing data after the lossless compression; and the Mura repair module is used for decompressing the data in the storage, and repairing Mura of the decompressed original image data to generate information feed to the liquid crystal display panel.

In one embodiment, the lossless compression module further calculates difference values between the acquired image data by: determining, a value Dmn of a pixel in row m and column n of the acquired image data; obtaining, based on the value Dmn of the pixel and a value of each pixel in row in where the pixel with the value Dmn is located, a set of difference values related to row m by calculating the values of differences between adjacent pixels, and obtaining, based on the value Dmn of the pixel and a value of each pixel in column n where the pixel with the value Dmn is located, a set of difference values related to column n by calculating difference values between adjacent pixels; obtaining, based on a value of each pixel in columns other than column n, a set of difference values related to the columns other than column n by calculating difference values between adjacent pixels; and using the value Dmn of the pixel, the set of difference values related to row m and sets of difference values related to each of the columns as the data after the lossless compression.

In one embodiment, the Mura repair module further decompresses the data after the lossless compression in the storage by: calculating, sequentially based on the value Dmn of the pixel and the set of difference values related to row m, values of all pixels of row m in the original image by addition; and calculating, sequentially based on the values of all pixels in row m and the sets of difference values related to each column, values of all pixels of each column in the original image by addition, such that values of all pixels in the original image data are obtained.

In one embodiment, the lossless compression module further calculates difference values between the acquired image data by: determining, a value Dmn of a pixel in row m and column n in the acquired image data; obtaining, based on the value Dmn of the pixel and a value of each pixel in row m where the pixel with the value Dmn is located, a set of difference values related to row in by calculating the values of differences between adjacent pixels, and obtaining, based on the value Dmn of the pixel and a value of each pixel in column n where the pixel with the value Dmn is located, a set of difference values related to column n by calculating the difference values between adjacent pixels; obtaining, based on a value of each pixel in rows other than row in, a set of difference values related to the rows other than row m by calculating difference values between adjacent pixels; and using the value Dmn of the pixel, the set of difference values related to column n and sets of difference values related to each of the rows as the data after the lossless compression.

In one embodiment, the Mura repair module further decompress the data after the lossless compression in the storage by: calculating, sequentially based on the value Dmn of the pixel and the set of difference values related to column n, values of all pixels of column n in the original image data by addition; and

calculating, sequentially based on the values of all pixels in column n and the sets of difference values related to each row, values of all pixels in each row of the original image data by addition, such that values of all pixels in the original image data are obtained.

According to another aspect of the present disclosure, a method for repairing poor display in a liquid crystal display panel is further provided, comprising steps of: acquiring image data of the liquid crystal display panel containing poor display areas; calculating difference values between the acquired image data to perform lossless compression; storing data after the lossless compression; and decompressing on the data in the storage, and repairing Mura of the decompressed original image data to generate feedback information.

In one embodiment, the step of calculating difference values between the acquired image data to perform lossless compression comprises: determining a value Dmn of a pixel in row m and column n of the acquired image data; obtaining, based on the value Dmn of the pixel and a value of each pixel in row m where the pixel with the value Dmn is located, a set of difference values related to row m by calculating the values of differences between adjacent pixels, and obtaining, based on the value Dmn of the pixel and a value of each pixel in column n where the pixel with the value Dmn is located, a set of difference values related to column n by calculating difference values between adjacent pixels; obtaining, based on a value of each pixel in columns other than column n, a set of difference values related to the columns other than column n by calculating difference values between adjacent pixels; and using the value Dmn of the pixel, the set of difference values related to row m and sets of difference values related to each of the columns as the data after the lossless compression.

In one embodiment, the step of decompressing the data after the lossless compression in the storage further comprises: calculating, sequentially based on the value Dmn of the pixel and the set of difference values related to row m, values of all pixels of row m in the original image by addition; and calculating, sequentially based on the values of all pixels in row m and the sets of difference values related to each column, values of all pixels of each column in the original image by addition, such that values of all pixels in the original image data are obtained.

In one embodiment, the step of calculating difference values between the acquired image data further comprises: determining, a value Dmn of a pixel in row in and column n in the acquired image data; obtaining, based on the value Dmn of the pixel and a value of each pixel in row m where the pixel with the value Dmn is located, a set of difference values related to row in by calculating the values of differences between adjacent pixels, and obtaining, based on the value Dmn of the pixel and a value of each pixel in column n where the pixel with the value Dmn is located, a set of difference values related to column n by calculating the values of differences between adjacent pixels; obtaining, based on a value of each pixel in rows other than row m, a set of difference values related to the rows other than row m by calculating difference values between adjacent pixels; and using the value Dmn of the pixel, the set of difference values related to column n and sets of difference values related to each of the rows as the data after the lossless compression.

In one embodiment, the step of decompressing the data in the storage further comprises: calculating, sequentially based on the value Dmn of the pixel and the set of difference values related to column n, values of all pixels of column n in the original image data by addition; and calculating, sequentially based on the values of all pixels in column n and the sets of difference values related to each row, values of all pixels in each row of the original image data by addition, such that values of all pixels in the original image data are obtained.

Compared with the prior art, one or more embodiments of the present disclosure may have the following advantages:

According to the present disclosure, after performing lossless compression/decompression on the acquired image data of the liquid crystal display panel containing poor display areas, which is to be stored in the storage, Mura elimination is performed on the decompressed original image data by virtue of the De-Mura algorithm, and then the feedback information is output to the panel. By mean of this, both the capacity of the storage and the cost can be reduced without degrading the effect of De-Mura processing.

Other features and advantages of the present disclosure will be illustrated in the following description, and partially become apparent from the description or may be understood through implementing the present disclosure. The objectives and other advantages of the present disclosure may be realized and obtained through the structures specified in the description, claims, and accompanying drawings.

### BRIEF DESCRIPTION OF THE DRAWINGS

The accompanying drawings are provided for further understanding the present disclosure, and constitute a part of the description for interpreting the present disclosure together with the embodiments of the present disclosure, rather than limit to the present disclosure, wherein:

FIG. 1 is a structural schematic diagram of a system for repairing poor display in a liquid crystal display panel according to one embodiment of the present disclosure;

FIG. 2 is a flow schematic diagram of a method for repairing poor display in a liquid crystal display panel according to one embodiment of the present disclosure;

FIG. 3 is a schematic diagram of an array of pixel data of a liquid crystal display panel according to one embodiment of the present disclosure;

FIG. 4(a) and FIG. 4(b) are diagrams of illustrating a pattern of performing lossless compression on the original image data information according to an embodiment of the present disclosure;

FIG. 5(a) and FIG. 5(b) are diagrams of illustrating a pattern of performing decompression on the compressed data after compression according to an embodiment of the present disclosure.

### DETAILED DESCRIPTION OF THE EMBODIMENTS

To make the objectives, technical solutions and advantages of the present disclosure more apparent, the present disclosure is further discussed in detail below in conjunction with the accompanying drawings.

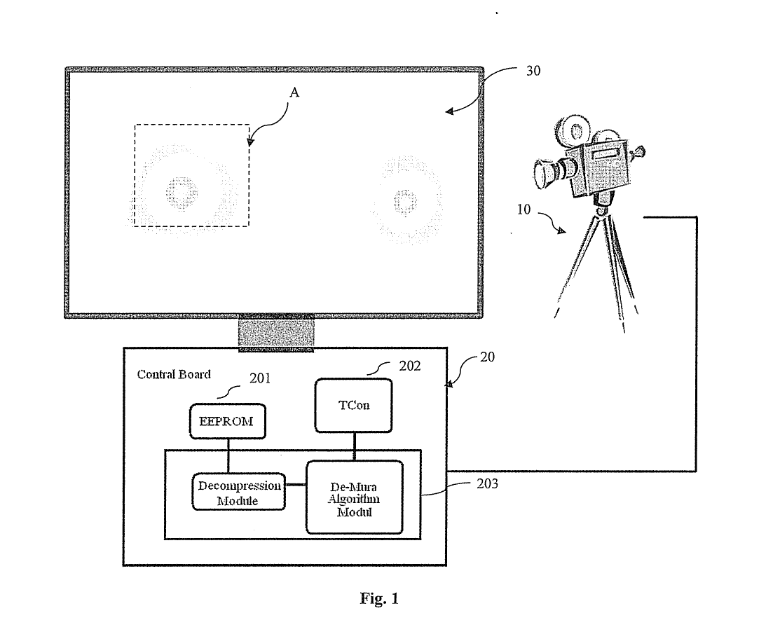

FIG. 1 is a structural schematic diagram of a system for repairing poor display in a liquid crystal display panel according to one embodiment of the present disclosure. Respective compositions and functions of the system are illustrated in detail below with reference to FIG. 1.

As shown in FIG. 1, the system comprises a camera 10, a control board 20 and a liquid crystal display panel (“display panel” for short) 30 electrically connected with the control board 20.

Before detection, the display panel 30 is lighten by a driver (not shown) , and can be driven to a specific gray-scale, for example, in a fully-bright state, a 50% gray-scale state or a fully-dark state. In the example, it can be seen from FIG. 1 that two poor display areas (Mura), such as an area A, occur in the screen of the display panel 30, and these areas are in an unfixed shape and include at least two planar-like Mura areas with blurred pixel edge.

Then, under a condition of meeting a certain environment temperature, humidity, brightness, shooting distance, viewing angle and the like, the current image data of the liquid crystal display panel containing these Mura areas is acquired by the camera 10, e.g., a CCD (charge coupled device). The camera 10 transmits the acquired original image data to the control board 20 to perform an image processing and a De-Mura processing.

The control board 20 comprises a storage (i.e., EEPROM) 201, a time sequence control circuit (TCon) 202, an image processing module 203, and a lossless compression module which is not shown in the figure. The image processing module 203 comprises a decompression module and a De-Mura algorithm module.

In this case, the storage 201 is used to store the image data compressed by the lossless compression module. The decompression module electrically connected with storage 201 performs decompression processing on the compressed data in the storage 201, and transmits the decompressed original image data to the De-Mura algorithm module to perform corresponding processing.

The De-Mura algorithm module is used for improving Mura. The De-Mura algorithm module calculates the decompressed original image data with parameters stored in the storage 201 by virtue of a De-Mura algorithm to obtain corresponding feedback information, and returns the feedback information to the liquid crystal display panel 30, such that image Mura is improved.

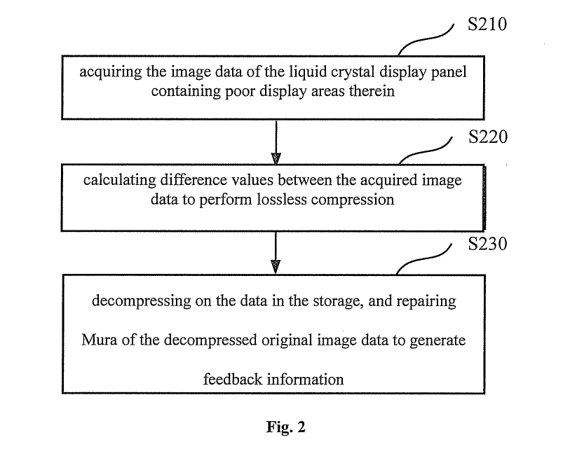

On the other hand, the present disclosure further provides a method for repairing poor display in a liquid crystal display panel, as specifically shown in FIG. 2. The method is illustrated in detail below with reference to FIG. 1 together with FIG. 2.

Firstly, the camera 10 acquires the image data of the display panel 30 containing poor display areas therein, and then transmits the acquired original data to the control board 20 (step S210).

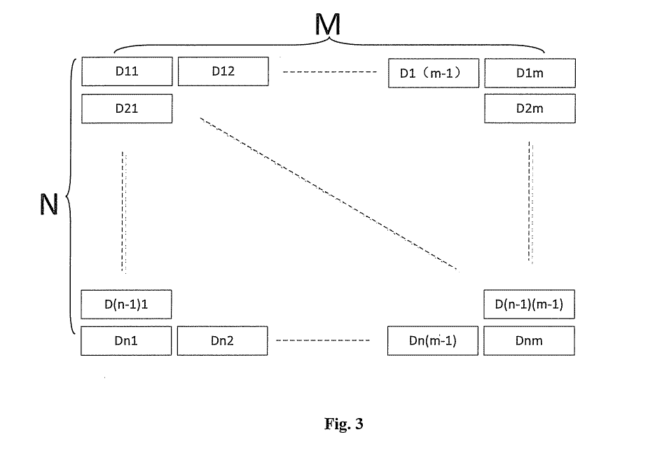

In step S220, before the data is stored in the storage 201 of the control board 20, the lossless compression module needs to calculate difference values between the acquired original data n (as shown in FIG. 3) to perform lossless compression, such that the compressed data is obtained and finally stored into the EEPROM 201.

It should be noted that, since the result of Mura elimination of a liquid crystal display panel may influence the display effect of the liquid crystal display to a great extent at the later time, the integrity and authenticity of the image data to be processed must be guaranteed during Mura elimination for the liquid crystal display panel. That is, the loss of the image data to be processed should be avoided. Therefore, the compression step involved in the example is required to be lossless. Preferably, a method by calculating the difference between pixels is used to compress the original image data. Then, the compressed data subjected to difference calculation may be stored in the EEPROM.

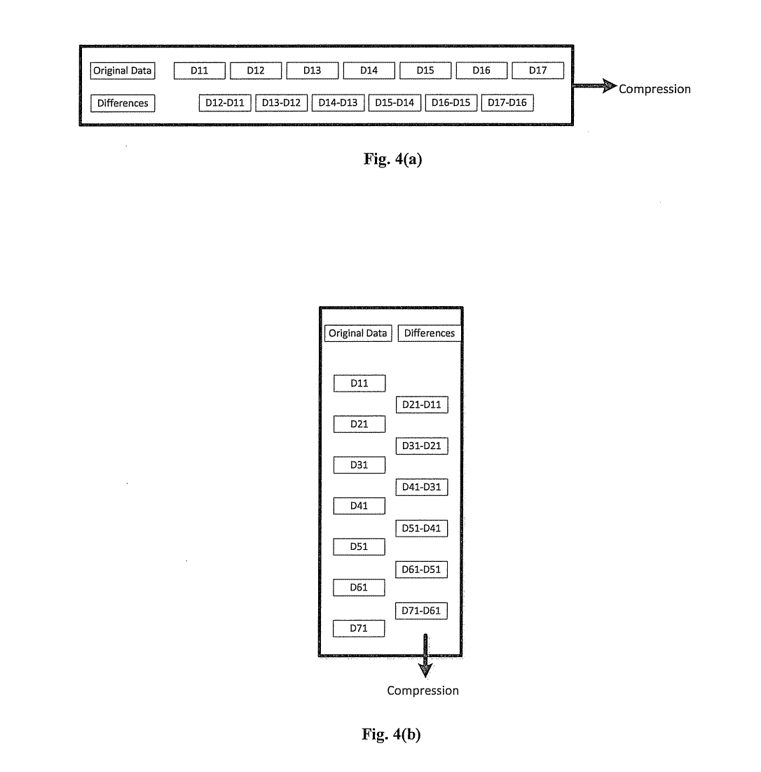

Specifically, row number M=7 and column number N=7 are taken as an example for illustration, and the compression process includes difference calculation for values of row and difference calculation for values of column, as shown in FIG. 4(a) and FIG. 4(b).

More specifically, how to calculate the difference of the first row is illustrated below. Firstly, a value D11 of a pixel located in row 1 and column 1 in the acquired image data of the liquid crystal display panel is determined, and difference calculation is performed between D11 and a value of a pixel adjacent to and located in the same row with D11, i.e., a value D12 of a pixel in row 1 and column 2, to obtain a difference D12-D11. With regard to the value of pixel D12, difference calculation is also performed between D12 and a value of a pixel adjacent to and located in the same row with it, i.e., a value D13 of a pixel in row 1 and column 3, to obtain a difference D13-D12. Difference calculation related to other adjacent pixels is similar to the above-mentioned method, and not further described in detail herein. Finally, a set of difference values related to row 1 as shown in FIG. 4(a) is obtained. It should be noted that, only the differences of the row 1 needs to be calculated, while differences related to other rows do not.

In addition, the differences of respective columns also need to be calculated. An example is merely taken by the column 1 for illustration below, while the differences related to other columns may also be calculated according to the following steps. Specifically, referring to FIG. 4(b), firstly, a value D11 of a pixel located in row 1 and column 1 in the image data is determined, and difference calculation is performed between the value of pixel D11 and a value of a pixel adjacent to and located in the same column with D11, i.e., a value D21 of a pixel in row 2 and column 1, to obtain a difference D21-D11; with regard to the value of pixel D21, difference calculation is also performed between the value D21 and a value of a pixel adjacent to and located in the same column with D21, i.e., a value D31 of a pixel in row 3 and column 1, to obtain a difference D31-D21. The difference calculation related to other adjacent pixels is similar to the above-mentioned method, and not further described in detail herein.

Through the above-mentioned compression calculation, contents stored in the EEPROM merely include the value of the pixel in row 1 and column 1 (D11), one set of difference values related to row 1 and sets of difference values related to respective columns. Due to the characteristic of Mura, i.e., a gray-scale difference between two adjacent pixels is low, the number of bits for the differences is much lower than the actual original data quantity, such that a large storage space can be saved, and then the cost can be reduced.

Finally, decompression processing is performed on the compressed information by the image processing module 203, then the De-Mura processing (Mura repair) is performed on the decompressed original image data to obtain feedback information, and finally the feedback information is output onto the display panel 30 (step S230). Specifically, the decompression module is used to decompress the compressed information, and then the De-Mura algorithm module is used for the later processing.

During the decompression process, the value of the pixel in row 1 and column 1 (D11) in the storage EEPROM is needed, wherein a value of each pixel in row 1 of the original image data are sequentially solved by virtue of difference inverse calculation based on the value of pixel D11 and the stored set of difference values related to row 1. Then, based on the obtained value of each pixel in row 1 and the set of difference values related to the column where said pixel is located, a value of each pixel in respective columns of the original image data are sequentially solved by virtue of difference inverse calculation, such that all the original image information is solved.

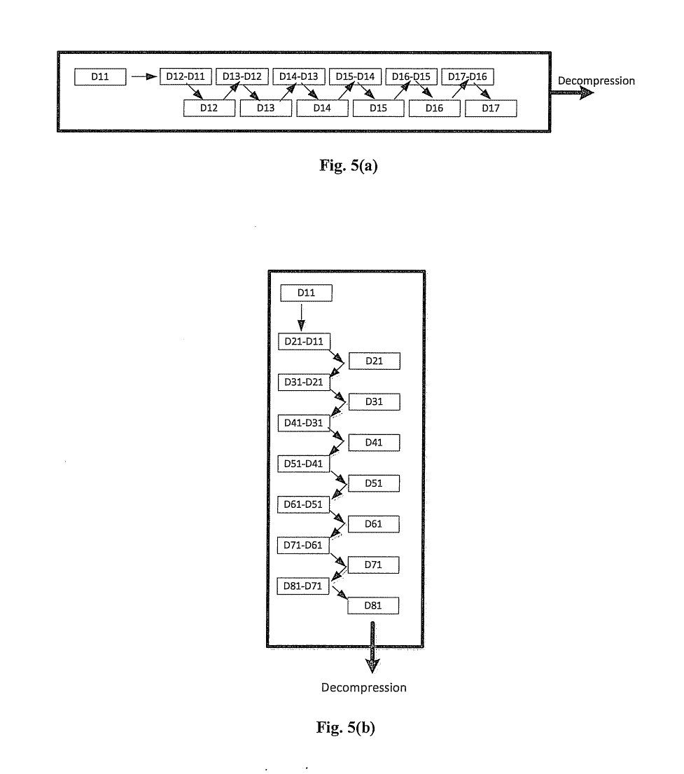

More specifically, with regard to the solution for the value of each pixel in row 1 of the original data, as shown in FIG. 5(a), an addition calculation is performed on a first value of the set of difference values related to row 1, i.e., D12-D11, and the value D11 of row 1 and column 1 to obtain the value of pixel D12. Further, the value D13 is obtained by virtue of D12 and a second value D13-D12 of the set of difference values related to row 1. Other original data are also solved according to the above-mentioned method and not described in detail herein. By this way, the values of row 1 in the original data are obtained.

With regard to the solution for the values of the pixels in each column in the original data, the values D21-D71 of the column where the pixel D11 is located are obtained by virtue of a method similar to the above-mentioned, and the details may be referred to FIG. 5(b) and not further described herein.

The De-Mura algorithm module may processes original data of Mura obtained by decompression to eliminate Mura.

It should be noted that, the above-mentioned difference compression/decompression algorithm is merely one example. For example, during the compression process, it is applicable that the set of difference values related to column 1 and the sets of difference values; related to the respective rows can also be obtained based on the value D11 of the pixel in row 1 and column 1, and then the value of pixel D11 and the obtained set of difference values are stored. Alternatively, during the compression process, it is applicable that a set of difference values related to row m and sets of difference values related to the respective columns are obtained based on a value Dmn of a pixel in row m and column n, or a set of difference values related to column n and sets of difference values related to the respective rows are obtained based on the value Dmn of the pixel in row m and column n, and then the value Dmn and the obtained sets of difference values are stored. It is readily to understand that, the values of all pixels in an original image of Mura may be obtained during the decompression process with reference to a method similar to the above-mentioned.

More specifically, the lossless compression/decompression process may be summarized below:

### The First Mode

The lossless compression comprises steps of: determining a value Dmn of a pixel in row m and column n of the acquired image data; obtaining, based on the value Dmn of the pixel and a value of each pixel in row m where the pixel with the value Dmn is located, a set of difference values related to row m by calculating the values of differences between adjacent pixels, and obtaining, based on the value Dmn of the pixel and a value of each pixel in column n where the pixel with the value Dmn is located, a set of difference values related to column n by calculating difference values between adjacent pixels; obtaining, based on a value of each pixel in columns other than column n, a set of difference values related to the columns other than column n by calculating difference values between adjacent pixels; and using the value Dmn of the pixel, the set of difference values related to row m and sets of difference values related to each of the columns as the data after the lossless compression.

The corresponding decompression processing comprises steps of: calculating, sequentially based on the value Dmn of the pixel and the set of difference values related to row m, values of all pixels of row m in the original image by addition; and calculating, sequentially based on the values of all pixels in row m and the sets of difference values related to each column, values of all pixels of each column in the original image by addition, such that values of all pixels in the original image data are obtained.

### The Second Mode

The lossless compression comprises steps of determining a value Dmn of a pixel of row in and column n in the acquired image data; obtaining, based on the value Dmn of the pixel and a value of each pixel in row m where the pixel with the value Dmn is located, a set of difference values related to row in by calculating the values of differences between adjacent pixels, and obtaining, based on the value Dmn of the pixel and a value of each pixel in column n where the pixel with the value Dmn is located, a set of difference values related to column n by calculating the values of differences between adjacent pixels; obtaining, based on a value of each pixel in rows other than row m, a set of difference values related to the rows other than row in by calculating difference values between adjacent pixels; and using the value Dmn of the pixel, the set of difference values related to column n and sets of difference values related to each of the rows as the data after the lossless compression.

The corresponding decompression processing comprises steps of: calculating, sequentially based on the value Dmn of the pixel and the set of difference values related to column n, values of all pixels of column n in the original image data by addition; and calculating, sequentially based on the values of all pixels in column n and the sets of difference values related to each row, values of all pixels in each row of the original image data by addition, such that values of all pixels in the original image data are obtained.

In conclusion, according to the present disclosure, the acquired image data of the liquid crystal display panel containing poor display areas therein and to be stored in the storage, after subjective to the lossless compression/decompression, further goes through the De-Mura algorithm, and then is output to the panel, such that both the storage capacity of the storage and the production cost can be reduced without degrading the effect of De-Mura processing.

The foregoing descriptions are merely preferred specific embodiments of the present disclosure, but the protection scope of the present disclosure is not limited thereto. Any variations or alternatives readily conceivable by anyone familiar with this art within the disclosed technical scope of the present disclosure shall be incorporated in the protection scope of the present disclosure. Accordingly, the protection scope of the present disclosure should be subjected to the protection scope of the claims.

What is claimed is:

1. A system for repairing poor display in a liquid crystal display panel, comprising:
an image acquisition means, for acquiring image data of the liquid crystal display panel containing poor display areas; and
a control board, electrically connected with the liquid crystal display panel, and comprising:
a lossless compression module, for calculating difference values between the acquired image data to perform lossless compression;
a storage, for storing data after the lossless compression; and
a Mura repair module for decompressing the data in the storage, and repairing Mura of the decompressed original image data to generate information feed to the liquid crystal display panel.

2. The system of claim 1, wherein the lossless compression module further calculates difference values between the acquired image data by:
determining a value Dmn of a pixel in row m and column n of the acquired image data;
obtaining, based on the value Dmn of the pixel and a value of each pixel in row m where the pixel with the value Dmn is located, a set of difference values related to row m by calculating the values of differences between adjacent pixels, and obtaining, based on the value Dmn of the pixel and a value of each pixel in column n where the pixel with the value Dmn is located, a set of difference values related to column n by calculating difference values between adjacent pixels;
obtaining, based on a value of each pixel in columns other than column n, a set of difference values related to the columns other than column n by calculating difference values between adjacent pixels; and
using the value Dmn of the pixel, the set of difference values related to row in and sets of difference values related to each of the columns as the data after the lossless compression.

3. The system of claim 2, wherein the Mura repair module further decompresses the data after the lossless compression in the storage by:
calculating, sequentially based on the value Dmn of the pixel and the set of difference values related to row m, values of all pixels of row m in the original image by addition; and
calculating, sequentially based on the values of all pixels in row m and the sets of difference values related to each column, values of all pixels of each column in the original image by addition, such that values of all pixels in the original image data are obtained.

4. The system of claim 1, wherein the lossless compression module further calculates difference values between the acquired image data by:
determining, a value Dmn of a pixel of row m and column n in the acquired image data;
obtaining, based on the value Dmn of the pixel and a value of each pixel in row m where the pixel with the value Dmn is located, a set of difference values related to row m by calculating the values of differences between adjacent pixels, and obtaining, based on the value Dmn of the pixel and a value of each pixel in column n where the pixel with the value Dmn is located, a set of difference values related to column n by calculating the values of differences between adjacent pixels;
obtaining, based on a value of each pixel in rows other than row m, a set of difference values related to the rows other than row m by calculating difference values between adjacent pixels; and
using the value Dmn of the pixel, the set of difference values related to column n and sets of difference values related to each of the rows as the data after the lossless compression.

5. The system of claim 4, wherein the Mura repair module further decompress the data after the lossless compression in the storage by:
calculating, sequentially based on the value Dmn of the pixel and the set of difference values related to column n, values of all pixels of column n in the original image data by addition; and
calculating, sequentially based on the values of all pixels in column n and the sets of difference values related to each row, values of all pixels in each row of the original image data by addition, such that values of all pixels in the original image data are obtained.

6. A method for repairing poor display in a liquid crystal display panel, comprising steps of:
acquiring image data of the liquid crystal display panel containing poor display areas;
calculating difference values between the acquired image data to perform lossless compression;
storing data after the lossless compression; and
decompressing on the data in the storage, and repairing Mura of the decompressed original image data to generate feedback information.

7. The method of claim 6, wherein the step of calculating difference values between the acquired image data to perform lossless compression comprises:
determining, a value Dmn of a pixel in row in and column n of the acquired image data;
obtaining, based on the value Dmn of the pixel and a value of each pixel in row m where the pixel with the value Dmn is located, a set of difference values related to row m by calculating the values of differences between adjacent pixels, and obtaining, based on the value Dmn of the pixel and a value of each pixel in column n where the pixel with the value Dmn is located, a set of difference values related to column n by calculating difference values between adjacent pixels;
obtaining, based on a value of each pixel in columns other than column n, a set of difference values related to the columns other than column n by calculating difference values between adjacent pixels; and
using the value Dmn of the pixel, the set of difference values related to row m and sets of difference values related to each of the columns as the data after the lossless compression.

8. The method of claim 7, wherein the step of decompressing the data after the lossless compression in the storage further comprises:
calculating, sequentially based on the value Dmn of the pixel and the set of difference values related to row m, values of all pixels of row m in the original image by addition; and
calculating, sequentially based on the values of all pixels in row m and the sets of difference values related to each column, values of all pixels of each column in the original image by addition, such that values of all pixels in the original image data are obtained.

9. The method of claim 6, wherein the step of calculating difference values between the acquired image data further comprises:
determining, a value Dmn of a pixel of row m and column n in the acquired image data;
obtaining, based on the value Dmn of the pixel and a value of each pixel in row m where the pixel with the value Dmn is located, a set of difference values related to row in by calculating the values of differences between adjacent pixels, and obtaining, based on the value Dmn of the pixel and a value of each pixel in column n where the pixel with the value Dmn is located, a set of difference values related to column n by calculating the values of differences between adjacent pixels;
obtaining, based on a value of each pixel in rows other than row m, a set of difference values related to the rows other than row m by calculating difference values between adjacent pixels; and
using the value Dmn of the pixel, the set of difference values related to column n and sets of difference values related to each of the rows as the data after the lossless compression.

10. The method of claim 9, wherein, the step of decompressing on the data in the storage further comprises:
calculating, sequentially based on the value Dmn of the pixel and the set of difference values related to column n, values of all pixels of column n in the original image data by addition; and
calculating, sequentially based on the values of all pixels in column n and the sets of difference values related to each row, values of all pixels in each row of the original image data by addition, such that values of all pixels in the original image data are obtained.
